(19) United States
(12) Patent Application Publication
(10) Pub. No.: US 2002/0185487 A1
(43) Pub. Date: Dec. 12, 2002

(54) Ceramic heater with heater element and method for use thereof

(76) Inventors: Ramesh Divakar, Williamsville, NY (US); Roger J. Lin, Framingham, MA (US); Morteza Zandi, Shrewsbury, MA (US); Brian C. LaCourse, Pepperell, MA (US); Ara M. Vartabedian, Hudson, MA (US); Jeffrey J. Kutsch, Oxford, MA (US)

Correspondence Address: ZAGORIN O'BRIEN & GRAHAM LLP, 401 W 15TH STREET, SUITE 870, AUSTIN, TX, 78701, US

(21) Appl. No.: 09/847,747

(22) Filed: May 2, 2001

(51) Int. Cl. H05B 3/68

(52) U.S. Cl. 219/444.1; 219/468.1

(57) ABSTRACT

A ceramic heater for use as a platform or support in producing a semiconductor wafer is described. A method for use of the ceramic heater as well as a method for controlling the temperature of a semiconductor wafer is provided. In a exemplary embodiment, the heater is made from a ceramic compound which has a thermally conductive ceramic layer and a ceramic heater element. In this embodiment, the thermally conductive ceramic layer is aluminum nitride doped with oxygen at such a level that it promotes thermal conductivity. The heater may also have a thermally insulative ceramic layer comprised of a mixture of aluminum nitride with a dopant at a level that makes the aluminum nitride thermally insulating. The heater element may be embedded within the ceramic chuck in a variety of shapes and configurations as necessary and as particular to the semiconductor processing requirements. In a preferred embodiment, the heating element is about 5% to about 50% by weight molybdenum disilicide, about 5% to about 40% by weight silicon carbide and about 15% to about 70% by weight aluminum nitride.

### BACKGROUND OF THE INVENTION

1. Field of the Invention

The present invention is related to a ceramic heater and, more particularly, to a ceramic heater for heating a semiconductor wafer substrate and to a method for heating the wafer.

2. Description of Related Art

In the manufacture of semiconductor devices, a substrate, such as a semiconductor wafer, may be produced by, for example, physical vapor deposition (PVD) or chemical vapor deposition (CVD). The PVD technique results in the deposition of a semiconductor material onto a substrate surface. In contrast, the CVD technique involves a chemical reaction and the reaction product is deposited on a substrate surface. Specific examples of CVD techniques include plasma-enhanced chemical vapor deposition (PECVD) and organometallic vapor phase epitaxy (OMVPE). The latter may also be referred to as metal organic chemical vapor deposition (MOCVD).

The MOCVD technique typically involves growing thin layers of a semiconductor compound wherein metal organic compounds are decomposed near the surface of a heated substrate wafer in the presence of a hydride compound. The PECVD technique typically involves a capacitively coupled system wherein a gas is passed between charge plates energized by, for example, direct current, audio, radio frequency (RF), or even microwave sources to change the feed gas into plasma. The plasma generally contains species, such as free radicals and ions, which react near or at the surface of the substrate, and the reaction product subsequently deposits upon the substrate surface in a controlled and orderly design.

In any of these techniques, the gas pressure, gas composition, gas flow rate and substrate temperature significantly influence the manner of deposition and hence, the quality of the produced semiconductor wafers. For example, control of the substrate temperature may significantly influence deposition by determining the rate of reaction, and consequently, the deposition or growth rate. Accordingly, some improvement efforts have focused on controlling the wafer temperature.

For example, Niori et al., in U.S. Pat. No. 5,280,156, describe a wafer heating apparatus with a ceramic substrate and a dielectric layer. The wafer heating apparatus also includes a heat generating resistance element embedded within the ceramic substrate, a film electrode formed on a front surface of the ceramic substrate, and a ceramic dielectric layer coating the film electrode.

In another example, Kawada et al., in U.S. Pat. No. 5,663,865, describe a ceramic electrostatic chuck with a built-in heater. The chuck described by Kawada et al. includes an integral body comprising a base body of a sintered mixture of boron nitride and aluminum nitride. A first pyrolytic graphite layer is formed on one surface of the base body serves as a resistance heater element. An insulating layer of pyrolytic boron graphite on the first pyrolytic graphite layer and a second pyrolytic graphite layer formed on the other surface of the base body serve as the electrodes for electrostatic chucking. A second insulating layer on the second pyrolytic graphite layer is formed from a pyrolytic composite nitride of boron and silicon.

In another patent, Kawada et al., in U.S. Pat. No. 5,566,043, describe a ceramic electrostatic chuck with a built-in heater having electrodes for the chuck made from an electroconductive ceramic bonded to a surface of a supporting substrate made from an electrically insulating ceramic. The chuck also has a heat-generating layer made from an electroconductive ceramic.

In addition, Hirai, in U.S. Pat. No. 5,866,883, teaches of a ceramic heater in a body of aluminum nitride, wherein the heating element is preferably made of tungsten or molybdenum; and Soma et al., in U.S. Pat. No. 5,231,690, also describe a wafer heater for use in semiconductor producing apparatus, wherein the heater comprises a discoidal substrate made of a substantially gas-tight, unitary sintered ceramic with a resistance-heating element.

In U.S. Pat. No. 6,204,489, Katsuda et al. describe the use of a “resistance control part” embedded in a heater substrate between the heating element and a high frequency electrode disposed proximate to the wafer surface. To prevent leak current from reaching the electrode, the “resistance control part” has a higher volume electrical resistivity than that of the surrounding substrate.

Although these efforts have produced acceptable improvements for heating a semiconductor wafer, other enhancements remain desirable.

### SUMMARY OF THE INVENTION

In accordance with one embodiment, the invention provides a heater comprising a thermally conductive ceramic layer and a thermally insulative ceramic layer. The heater further comprises a ceramic heater element embedded within the thermally conductive ceramic layer. In various applications, it can be desirable to provide thermally conductive and thermally insulative layers which exhibit substantially the same electrical resistivity.

The invention also provides a method for heating a semiconductor wafer comprising the steps of adjusting an electrical resistivity of a ceramic heater element, providing a heater comprising a thermally conductive ceramic layer, a thermally insulative ceramic layer and a ceramic heater element embedded within the thermally conductive layer, generating a quantity of thermal energy from the ceramic heater element and transferring at least a portion of the generated thermal energy to the semiconductor wafer.

In another embodiment, the invention provides a semiconductor wafer temperature controller comprising a thermally conductive ceramic layer for supporting the semiconductor wafer and a thermally insulative ceramic layer for supporting the thermally conductive ceramic layer. The semiconductor wafer temperature controller also has a ceramic heater element in thermal communication with the thermally conductive ceramic layer and positioned between the thermally conductive and thermally insulative ceramic layers. The wafer temperature controller also has an electrical power supply connected to the ceramic heater element, a sensor for measuring the temperature of the semiconductor wafer and a control loop connected to the sensor and the electrical power supply.

In yet another embodiment, the invention provides a semiconductor wafer heater comprising a thermally conductive ceramic layer for supporting a semiconductor wafer, a thermally insulative ceramic layer in contact with the thermally conductive ceramic layer and a ceramic heater element embedded between the thermally conductive ceramic layer and the thermally insulative ceramic layer. The thermally conductive ceramic layer, the thermally insulative ceramic layer and the ceramic heater element have substantially the same coefficient of thermal expansion.

In yet another embodiment, the invention provides a method of producing a ceramic heater comprising the steps of adding a first sintered ceramic to a mold, blending an electrically conductive ceramic and an electrically insulative ceramic into a mixture, transferring the mixture into the mold, blending a second sintered ceramic with a dopant, transferring the second ceramic with the dopant into the mold, and hot pressing the mold at a temperature of at least 1800° C. to produce the ceramic heater.

In accordance with another embodiment, the invention provides a heater comprising a thermally conductive ceramic layer and a thermally insulative ceramic layer. The heater further comprises a ceramic heater element between the thermally conductive and the thermally insulative ceramic layers.

In yet another embodiment, the invention provides a method for heating a semiconductor wafer comprising the steps of adjusting an electrical resistivity of a ceramic heater element, providing a heater comprising a thermally conductive ceramic layer, a thermally insulative ceramic layer and a ceramic heater element embedded between the thermally conductive and the thermally insulative layers. The method also provides the steps of generating a quantity of thermal energy from the ceramic heater element and transferring at least a portion of the generated thermal energy to the semiconductor wafer.

### BRIEF DESCRIPTION OF THE DRAWINGS

Preferred, non-limiting embodiments of the present invention will be described by way of example with reference to the accompanying drawings in which:

FIG. 1 is a schematic diagram of one embodiment of the ceramic heater of the present invention;

FIG. 2 is a flow diagram showing the steps of fabricating one embodiment of the present invention;

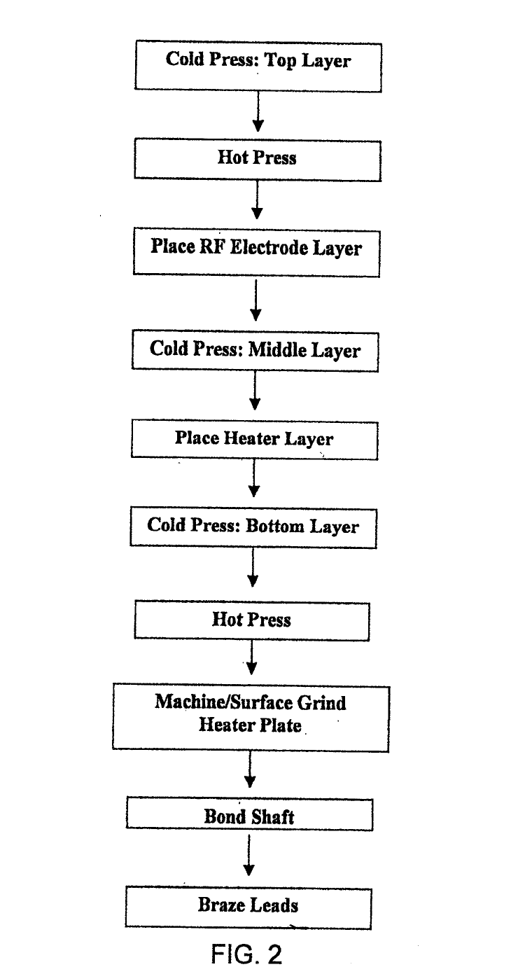

FIG. 3 is a graph showing the electrical resistivity of one embodiment of the heater element as a function of temperature; and

FIG. 4 is a graph showing the electrical resistivity of another embodiment of the heater element as a function of temperature.

### DETAILED DESCRIPTION

The present invention is directed to a wafer heating apparatus, or heater, comprising a thermally conductive ceramic layer and an embedded ceramic heater element. Preferably, the heater further includes a thermally insulative ceramic layer. The invention is also directed to a method of heating or controlling the temperature of a wafer, in particular a semiconductor wafer, by providing a plate with an incorporated heater layer or heater element. Among the notable advantages of present invention is the excellent compatibility in terms of thermal expansion between the individual components and materials of the heater assembly.

Various aspects and embodiments of the invention can be better understood with the following definitions. As used herein, a wafer heating apparatus or a heater generally refers to an apparatus typically used as a platform upon which a wafer, a semiconductor wafer for example, is placed during vapor deposition processes.

As used herein, thermally insulative is defined as that property of a material to resist heat transfer to another material or through itself. Thus, a thermally insulative material tends to resist heat transfer, either to another material or through itself. In contrast, thermally conductive refers to the property of a material to transfer or pass thermal energy or heat to another material or through itself. Thus, a thermally conductive material readily transfers thermal energy, either by conduction, convection or radiation, to another material or through itself. Also as used herein, electrical resistivity is defined as the property of a material to resist the conduction of an electrical current through itself. As used herein, the term “ceramic” includes all art-recognized ceramic materials, composites of the same, and composites of ceramics and metals and/or metal alloys.

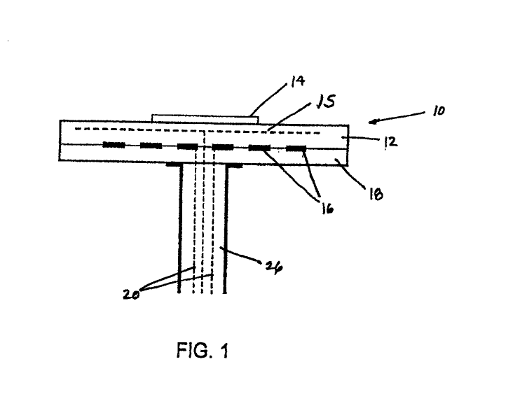

In the embodiment shown in FIG. 1, a heater 10 may have a plate 12 that supports a wafer 14. Heater 10 may have heater layer or heater element 16 embedded within plate or layer 12. Preferably, heater 10 further includes a layer 18 and electrical connectors 20 that typically connect heater element 16 to an electrical power supply. Alternatively, heater element 16 may be embedded between plate or layer 12 and layer 18.

In one aspect of the invention, plate 12 is a ceramic composite or compound. Preferably, plate 12 is a ceramic composite having sufficient rigidity to support wafer 14 during, for example, the vapor deposition. More preferably, plate 12 is a ceramic composite having high thermal conductivity such that the temperature of supported wafer 14 is substantially the same or equal to the temperature of the plate. Even more preferably, wafer 14 and plate 12 have substantially uniform temperature throughout the region of mutual contact. Thus, in one aspect, the temperature of plate 12 and wafer 14 differ by less than 2%, and preferably less than 1%.

In another aspect of an embodiment of the invention, plate 12 is a ceramic composite comprising at least one of aluminum oxide, aluminum oxide-titanium oxide, aluminum nitride (AlN), silicon nitride, silicon carbide (SiC), boron nitride, yttrium oxide (Y₂O₃) or yttria and yttrium aluminate (for example, Y₃Al₅O₁₂, YAlO₃, Al₂Y₄O₉). In another embodiment, the ceramic composite comprises at least one of aluminum nitride and silicon nitride. More preferably, the ceramic composite of plate 12 comprises aluminum nitride. In a preferred embodiment, the ceramic composite of plate 12 further includes a doping element, which modifies the thermal conductivity or other thermal properties of plate 12. Thus, in one embodiment of the invention, plate 12 is a thermally conductive ceramic layer comprising at least 50% by weight aluminum nitride with a dopant at a level sufficient to provide a high thermal conductivity. Preferably, the thermally conductive ceramic layer is at least 50% by weight aluminum nitride with oxygen at a level that increases the thermal conductivity of plate 12.

In another embodiment, the ceramic composite of plate 12 further includes additional components, such as sintering aids, bonding agents and other materials known in the art. For example, the additional components may include any of molybdenum, yttrium oxide, calcium oxide and calcium salts, such as calcium fluoride and calcium chloride. Thus, in one embodiment, plate 12 is a thermally conductive ceramic layer comprising aluminum nitride and further includes any of chromium oxide, silica, and any combination thereof which modifies the processing characteristics or the mechanical properties of the thermally conductive ceramic layer. In yet another embodiment, the thermally conductive ceramic layer further includes secondary phases formed by reactions between the ceramic matrix and additional components, which further modifies the electrical, mechanical or thermal properties of the thermally conductive ceramic layer. For example, the thermally conductive ceramic layer may comprise any of aluminum nitride, aluminum oxide, an oxynitride of aluminum such as aluminum oxynitride, aluminum carbide, yttrium oxide or yttria, calcium fluoride, calcium chloride, calcium oxide, calcium carbonate, calcium nitrate, chromium oxide, silica, boron nitride, yttrium aluminate and combinations thereof.

Optionally, the ceramic heater 10 further includes a coating (not shown) which protects the apparatus against chemical attack, erosion and corrosion. Preferably, the coating protects heater 10 against any degradation during vapor deposition operations. The coating may be applied to a surface of heater 10 and may comprise boron nitride, yttria, yttrium aluminate, aluminum trifluoride and diamond or diamond-like materials. Preferably, the coating has a thickness that is at least one micrometer (μm) and, preferably, the thickness is at least 10 μm.

Layer 18 serves as a supporting member of heater 10. Layer 18 is typically made of a material with sufficient strength and rigidity such that it is dimensionally and structurally stable throughout the operating conditions of heater 10. For example, layer 18 may be a ceramic, a metal, a metal alloy or a composite ceramic/metal or metal alloy. Preferably, layer 18 is formed from a ceramic composite or compound with low thermal conductivity such that substantially none or little heat transfers through layer 18. In this manner, layer 18 serves as a thermally insulative ceramic layer supports to heater 10 while inhibiting any heat transfer. In a preferred embodiment, the thermally insulative ceramic layer comprises at least one of aluminum oxide, aluminum oxide-titanium oxide, aluminum nitride, silicon nitride, silicon carbide, boron nitride, yttrium oxide or yttria, yttrium aluminate or any combination thereof. Preferably, the thermally insulative ceramic layer comprises at least one of aluminum nitride and silicon nitride.

In another embodiment, the thermally insulative layer is a ceramic composite with a doping element, which modifies a mechanical or electrical property of the thermally insulative layer. Preferably, the doping element provides additional desirable properties such as improved processing characteristics. In a particular embodiment, layer 18 is a thermally insulative ceramic layer comprising oxygen as a doping element within an aluminum nitride matrix. Preferably, the thermally insulative ceramic layer comprises at least about 0.1% by weight oxygen as the doping element and at least about 50% by weight, aluminum nitride.

As with the thermally conductive ceramic layer, the thermally insulative ceramic layer may further include additional components, such as sintering aids, bonding agents and other materials known in the art. For example, the additional components may include yttrium oxide, calcium oxide and calcium salts, such as calcium fluoride and calcium chloride. In another embodiment, the thermally insulative ceramic layer further includes chromium oxide, silica and any combination thereof. In another embodiment, the thermally insulative ceramic layer further includes secondary phases formed by reactions between the ceramic and additional components such as compounds including yttrium, aluminum and oxygen or yttrium aluminates. Thus, in a preferred embodiment, the thermally insulative ceramic layer comprises any of aluminum nitride, aluminum oxide, an oxynitride of aluminum such as aluminum oxynitride, aluminum carbide, yttrium oxide or yttria, calcium fluoride, calcium chloride, calcium oxide, calcium carbonate, calcium nitrate, chromium oxide, silicon oxide, boron nitride, yttrium aluminate and combinations thereof.

In yet another aspect of the invention, the thermally conductive and the thermally insulative ceramic layers comprise a ceramic with substantially the same coefficient of thermal expansion. Thus, in a particular embodiment, the thermally conductive ceramic layer and the thermally insulative ceramic layers comprise at least one of aluminum oxide, aluminum oxide-titanium oxide, aluminum nitride, aluminum carbide, silicon nitride, silicon carbide, boron nitride, yttrium oxide or yttria, yttrium aluminate or any combination thereof and wherein either the thermally conductive or the thermally insulative ceramic layers further comprises a dopant present within the respective ceramic matrices at a level sufficient to modify at least one of the mechanical and thermal physical properties of each layer. For example, the thermally conductive ceramic layer may comprise aluminum nitride with a dopant promoting thermal conductivity and the thermally insulative ceramic layer comprises aluminum nitride with a dopant inhibiting thermal conductivity. In this manner, the thermally insulative and the thermally conductive ceramic layers substantially comprise the same composition and, accordingly, have substantially or at least about the same coefficient to thermal expansion but with notably different thermal properties.

Heater element 16 is any such structure capable of generating a quantity of thermal energy. Typically, heater element 16 converts one form of energy to generate the thermal energy. For example, heater element 16 may convert electrical, radio or microwave energy into thermal energy. Thus, in one embodiment, heater element 16 may generate a quantity of thermal energy by converting an applied electrical current. Notably, heater element 16 may comprise an electrically resistive phase that resists the passage of the electrical energy and generates thermal energy. Accordingly, in one embodiment, heater element 16 comprises an electrically resistive ceramic of at least one of aluminum oxide, aluminum oxide-titanium oxide, aluminum nitride, silicon nitride, silicon carbide, boron nitride, yttrium oxide or yttria, yttrium aluminate or any combination thereof. In another embodiment, the electrically resistive ceramic composite or compound comprises a mixture of at least one of a nitride of aluminum and silicon as disclosed by Washburn et al., in U.S. Pat. Nos. 5,045,237 and 5,085,804, which are incorporated herein by reference in their entireties. Preferably, heater element 16 is a ceramic composite further comprising molybdenum disilicide (MoSi₂); and, more preferably, heater element 16 is a ceramic compound further comprising silicon carbide. In a particularly preferred embodiment, the molybdenum disilicide in heater element 16 is present in an amount between about 5% and about 50%, by weight; the silicon carbide is present in an amount between about 5% and about 40%, by weight; and the aluminum nitride is present in an amount between about 15% and about 70%, by weight.

In another embodiment, heater element 16 is a ceramic composite comprising aluminum nitride and any of molybdenum, molybdenum disilicide and silicon carbide. Even more preferably, heater element 16 comprises 42.7% by weight aluminum nitride and 57.3% by weight molybdenum.

Notably, the electrical resistivity, or even the electrical conductivity, of the mixture of molybdenum disilicide, silicon carbide and aluminum nitride may be adjusted by adjusting the composition of each of the concentrations of aluminum nitride, molybdenum, molybdenum disilicide and silicon carbide. In this manner, the electrical resistance of heating element 16 to an applied electrical current generates thermal energy, which may be thermally conducted through the thermally conductive ceramic layer, and in a preferred embodiment, to wafer 14.

As mentioned, the electrical resistivity can be tailored as needed and according to the required heating or processing requirement necessary during, for example, a vapor deposition operation. Furthermore, the heater element may be designed with a variety of configurations to tailor the resistivity and heat generation for each particular process. For example, the heater element may be formed as any of a variety of shapes such as discs, spirals or rectangular plates. Further, the heater element may have different or varying cross sections. The overall resistance of the heating element may be changed by, for example, changing the geometry, such as the length or cross-sectional area, and the resistivity of the heater material. In this way, two independent means for tailoring the resistance of the heater element or heater layer are provided. Thus, at least two degrees of freedom are available in designing the heater layer and provide superior temperature uniformity of the wafer in the top surface of plate 12, namely, a more robust heater element design resulting from a thicker cross-section with none or little change in resistance and a composite heater element with resistivity that may be varied by segments or sections.

In yet another embodiment, the thermally conductive ceramic layer and heater element 16 have the same or at least substantially the same coefficient of thermal expansion. More preferably, the thermally insulative ceramic layer has the same or substantially the same coefficient of thermal expansion as heater element 16. In a particularly preferred embodiment, the thermally conductive ceramic layer, heater element 16 and the thermally insulative ceramic layer have the same or substantially the same coefficient of thermal expansion. In a preferred embodiment, the difference in the coefficient of thermal expansion is about 0.5×10⁻⁶/°C.

In yet another embodiment, heater element 16 is positioned within the thermally conductive ceramic layer such as to minimize or even eliminate thermal losses to the surrounding environment when heater 10 is in operation. For example, heater element 16 may be a coil wound along the perimeter of the thermally conductive ceramic layer and, preferably, spirally winds into its center. In yet another embodiment, a second, or even a third heater element may be embedded within the thermally conductive ceramic layer. Thus, the plurality of heater elements may be used in an orchestrated or coordinated manner to control or regulate the temperature of the wafer or to control or regulate the heat transfer to the wafer. For example, heater 10 may have a first heater element embedded along or near the perimeter of the thermally conductive ceramic layer and a second heater element embedded centrally or at a position of minimal distance from the wafer. The second heater may be used to generate heat and raise or control the temperature of wafer 14 and the first heater element may be used to minimize heat transfer from the second heater element to the surrounding environment. This arrangement allows for better temperature control of wafer 14 because the first heater element may tend to insulate the second heater element from surrounding influences.

Electrical connections 20 may comprise, for example, a wire, a rod, a foil, a plate, a perforated foil or a perforated plate, a mesh, a screen printed layer or any other configuration that is suitable, as known in the art and may be fabricated from any suitable metal or from a combination of metals or alloys that allows conduction of an electrical current while being sufficiently structurally stable to allow for expansion and contraction associated with thermal cycling of heater 10. Electrical connections 20 may be joined to the heater layer by methods known in the art, such as brazing.

In an embodiment pertaining to the method of heating wafer 14, the electrical resistivity of heater element 16 may be adjusted or tailored according to the particular or specific requirements for processing or producing wafer 14. Notably, adjusting the electrical resistivity may comprise adjusting the ceramic composition of heater element 16 as mentioned above. For example, any ceramic compound comprising heater element 16 may include an electrically resistive phase and an electrically resistive phase wherein adjusting the electrical resistivity involves changing the composition of heater element 16 by either increasing or decreasing the relative amounts any of the electrically resistive and conductive phases in heater element 16. Specifically, the electrically resistive phase may be comprised of aluminum nitride and the electrically conductive phase may be comprised of any of molybdenum and molybdenum disilicide. Thus, the step of adjusting the electrical resistivity may comprise increasing or decreasing the relative composition of any of aluminum nitride, molybdenum and molybdenum disilicide.

Alternatively, adjusting the resistivity may comprise adding an additional component that either increases or decreases the overall resistivity of heater element 16. In a preferred embodiment, the thermally conductive ceramic layer is at least about 50% by weight aluminum nitride and the ceramic heater element 16 is at least about 5% to about 75% by weight aluminum nitride and about 25% to about 95% by weight, molybdenum disilicide. In yet another embodiment, heater element 16 is at least about 5% to about 75% by weight of aluminum nitride and about 25% to about 95% by weight of molybdenum. In yet another embodiment, the electrical resistivity may be adjusted by changing the cross-sectional dimension or the total length of heater element 16. Most preferably, the electrical resistivity may be adjusted using any or a combination of the above methods.

The method also includes embedding heater element 16 within the thermally conductive ceramic layer, and generating a quantity of thermal energy from heater element 16. Further, the method includes transferring at least a portion of the generated thermal energy from heater element 16 to semiconductor wafer 14. The step of generating thermal energy typically involves converting electrical energy by, for example, applying an electrical current from electrical power source 22 through electrical connections 20 to heater element 16. In particular, the applied electrical current may be converted to thermal energy according to the known power law, P=I²R, where P is the generated power, I is the applied electrical current and R is the electrical resistance or resistivity of heater element 16.

The method may further include measuring the temperature of wafer 14 by using a sensor element 24. In one aspect of the invention, wafer 14 and the thermally conductive ceramic layer have the same or substantially the same temperature. In this way, sensor 24 may be used to measure, indirectly, the wafer temperature by measuring the temperature of the thermally conductive ceramic layer. Sensor 24 may be any temperature measuring device known in the art, such as a thermocouple or infrared detector.

In a preferred embodiment, the method further includes controlling the temperature of wafer by adjusting or regulating the amount of electrical current applied to heating element 16. Notably, the controller may include a control loop, such as a feedback or feedforward control loop, incorporating any of proportional, derivative, integral or a combination thereof to increase or decrease the amount of applied current. In a particular embodiment, the controller may comprise any microprocessor as known in the art such as a computer. Notably, the control loop may further incorporate any of fuzzy logic or artificial intelligence techniques to control the temperature of wafer 14.

In yet another embodiment, the heater may include at least one porous region (not shown) through plate 12. The porous region may further include a fluid such as a gas, which further provides heating or cooling to wafer 14. In yet another embodiment, the fluid performs as a heat transfer fluid to assist the temperature control of wafer 12 and preferably, in coordination with the operation of the ceramic heating element. Examples of such heat transfer fluids include helium, argon or other inert gas that do not participate in the semiconductor processing operation.

In yet another embodiment, heater 10 may further include a RF electrode 15 embedded within plate 12. In various embodiments plate 12 can comprise a thermally conductive ceramic layer having substantially uniform volume resistivity, specifically between heater element 16 and electrode 15. In a preferred embodiment, heater 10 further includes a shaft 26 for supporting plate 12, with or without layer 18. More preferably, shaft 26 surrounds or protects electrical connections 20 and any connections to any device or other included instrumentation or measurement devices, such as sensor 24, in plate 12 or layer 18. In yet another preferred embodiment, shaft 26 comprises a fourth ceramic compound. Most preferably, shaft 26 is thermally insulative and comprised of the same ceramic compound as layer 18.

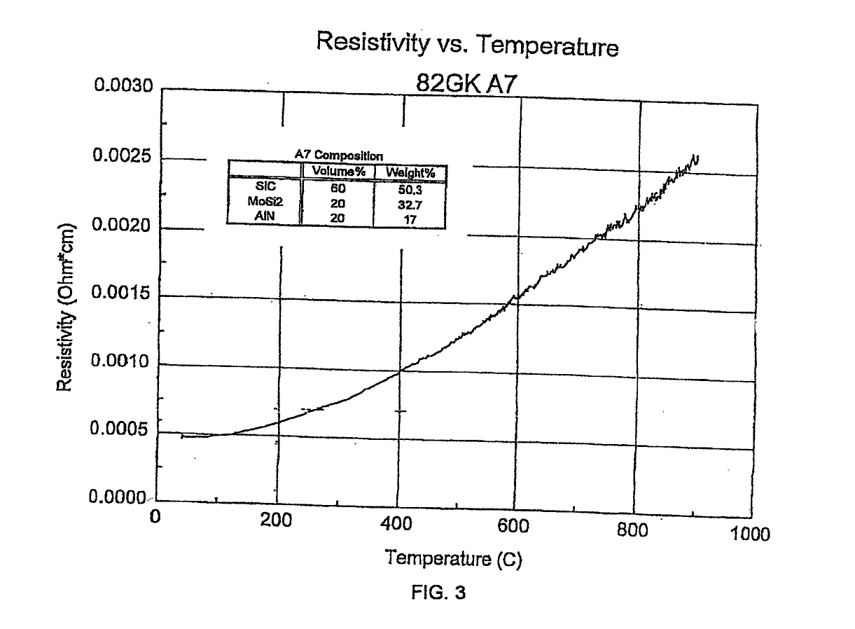

The typical process of fabricating the ceramic heater, as shown in the flowchart of FIG. 3, may involve several steps. Typically, a blank ceramic disc of the required diameter and thickness is prepared using known ceramic manufacturing techniques. The powder type with optional sintering and/or densification aids may be used and chosen such that a blank disc of high-density and high-thermal conductivity are obtained. This typically creates layer 12, as shown in FIG. 1. For example, a high purity aluminum nitride powder may be used to produce a thermally conductive layer. Preferably, the aluminum nitride powder is derived from carbothermal reduction processes. Yttria, for example, may be used as a sintering aid.

Densification may be accomplished either by pressureless sintering or by hot isostatic pressing or by hot pressing. If necessary, an RF electrode is placed on the blank. This RF electrode is typically a refractory metal, such as molybdenum, and may be screen-printed on the blank. Alternatively, a pre-fabricated RF electrode of molybdenum or other refractory metal may simply be placed on the blank. The densified blank is typically transferred to a graphite mold having a graphite sleeve insert. Additional aluminum nitride powder with optional sintering and/or densification aids may then be placed on top of the RF electrode. The assembly may then be compacted in a press. In this way, a green powder compact is formed on top of the blank constituting an intermediate layer between the RF electrode and the heater layer.

A heater layer or heating element of a suitable design or predetermined design may then be placed on the green powder compact. This heater layer is typically made of the ceramic materials or mixture discussed above and can be formed by, for example, tape casting or gel casting. Alternatively, a heater layer may be formed by making an exact impression of the heater element on the green powder compact, preferably during the compaction of the powder, and then filling the impression with a powder mixture comprising the heater layer material. After the heater layer or the powder is placed in position, additional powder is added on the heater layer. Preferably, this additional powder comprises a powder of a type that has a lower thermal conductivity than the blank obtained from the thermally conductive layer. As with the thermally conductive layer, sintering and/or densification aids may be used and incorporated within the thermally insulative powder. The assembly is then typically compacted in a press in a similar manner as described above with the thermally conductive layer.

The assembly may then be densified using any of the various processes available for densification of ceramics. For example, densification may be performed by hot pressing at the appropriate temperature and pressure required for the simultaneous densification of the ceramic and refractory metal electrode and heater layer.

Upon densification, a composite heater plate is typically produced. A ceramic shaft, typically fabricated separately, may be added to the back of the produced heater plate by techniques known in the art, such as brazing or diffusion bonding. In this way, the leads supplying power to the heater layer and the RF electrode are joined to the respective layers. Any required machining of the heater plate or shaft may then be performed subsequently.

The invention may be further understood with reference to the following example. The examples are intended to serve as illustrations and not as limitations to the present invention as defined in the claims herein.

### Example 1

A graphite mold containing a graphite sleeve insert was placed in a hydraulic press. A graphite spacer disc with a thin, circular sheet of graphite paper was placed within the mold/sleeve assembly. High-purity aluminum nitride powder, greater than 99.9% aluminum nitride, derived from a carbothermal reduction process and including approximately 0.9% by weight oxygen and 3% by weight of Y₂O₃, was placed into the mold/sleeve assembly on the circular graphite sheet. The powder was then compacted under pressure by hydraulically actuating the ram. Another thin circular sheet of graphite and a graphite spacer were placed on the green compact. The entire assembly was hot-pressed at 1850° C. under 3,000 psi in a nitrogen atmosphere. The resulting composite was an aluminum nitride blank of better than 99.6% of the theoretical density. The thermal conductivity at room temperature of a representative sample of this blank disc was measured to be about 175 watts/mK.

The surfaces of the produced disc blank were machined so that they were flat and parallel according to the desired tolerances. A molybdenum-based RF electrode was then screen-printed on the disc blank with a molybdenum-based screen printing ink and an appropriate screen that had a negative image of the desired electrode pattern. The diameter of the RF electrode was approximately 4.2 inches (107 mm). The green thickness of the screen-printed electrode was approximately 0.014 inch (356 μm) which results in a final thickness of 0.007 inch (178 μm) after densification.

The disc blank with the RF electrode was placed in a graphite mold/sleeve assembly. A graphite spacer and a thin graphite sheet were placed directly under the disc blank. Additional powder identical to that used in the preparation of the dense blank was placed on the RF electrode and compacted. Separately, a spirally-shaped heating element with a rectangular cross-section, approximately 4.0 inches (102 mm) in diameter and about 0.14 inch (356 μm) thick green was fabricated using the tape casting process. The target heater dimensions after densification was a maximum diameter of 4.0 inches (102 mm) and a thickness of 0.006 inches (152 μm). The heating element composition, not including the binder constituents, was about 50.3 weight % silicon carbide, 32.7 weight % molybdenum disilicide and 17 weight % aluminum nitride. The heating element was then placed and properly aligned on the green compact.

Another mixture of aluminum powder having about 2 weight % of oxygen was used to form the thermally insulative portion. No Y₂O₃ was added to this powder. In this way, the subsequently produced ceramic layer would be more thermally insulating than the earlier produced ceramic layer. This powder was then placed and compacted on the heating element in the graphite mold/sleeve. The entire assembly was subjected to hot pressing again at 1850° C. and 3,000 psi in a nitrogen atmosphere. The measured thermo-conductivity at room temperature of the thermally insulative layer was found to be about 60 watts/mK.

The resulting heater was an aluminum nitride-based composite heater plate having a heater layer and an RF electrode. The top layer and the layer between the RF electrode and the heater layer had a high thermal conductivity and the layer around and below the heater was thermally insulative.

FIG. 3 shows that heater element used in the assembly heater had a resistivity that increases as a function of temperature. Specifically, FIG. 3 shows that at a temperature above 400° C., the resistivity of heater elements having this particular composition increased at a substantially linear rate.

### EXAMPLE 2

The heater as prepared in the method described in Example 1 was made but with a mixture of molybdenum and aluminum nitride. Several mixtures were prepared to produce several heaters in order to classify and obtain a closer match between the coefficient of thermal expansion of aluminum nitride and the heater element while achieving a desired heater element resistivity. Table 1 shows the compositions of the various heater elements along with their coefficients of thermal expansion.

TABLE 1

| | | | | Coefficient |
|---|---|---|---|---|
| | | | Density, | of Thermal |
| Composition | Aluminum | Molybdenum | Theoretical | Expansion |
| Designation | nitride (wt. %) | (wt. %) | (g/cc) | (10⁻⁶/° C.) |
| M10 | 74.2 | 25.8 | 3.96 | 5.25 |
| M15 | 64.4 | 35.6 | 4.30 | 5.22 |
| M20 | 56.1 | 43.9 | 4.65 | 5.19 |
| M30 | 42.7 | 57.3 | 5.35 | 5.14 |

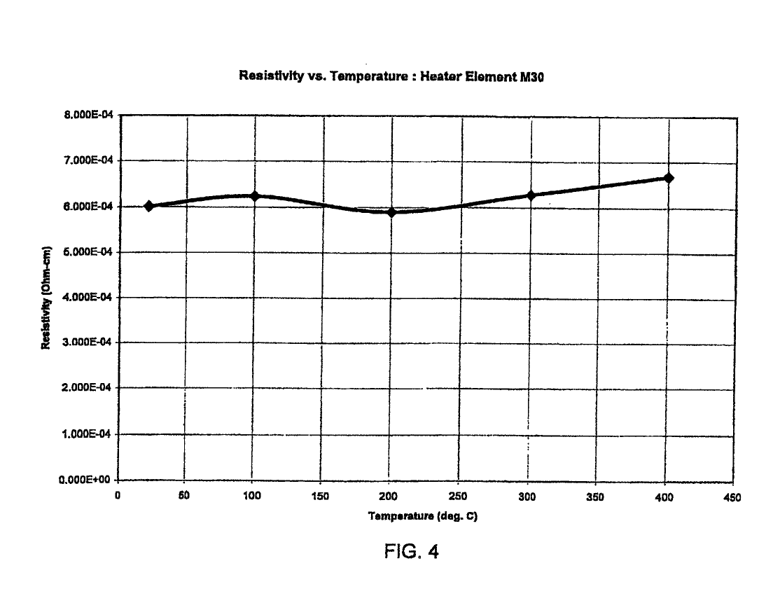

FIG. 4 shows the resistivity of the M30 composition as a function of temperature. In particular, FIG. 4 shows that the resistivity was fairly constant as a function of temperature up to about 350° C.

### EXAMPLE 3

A heater as produced similar to the method described in Example 1 was prepared and machined so that the two exposed surfaces were flat and parallel. Subsequently, the outer diameter was machined to 4.35 inches (110 mm) and access holes to the heater layer and RF electrode were machined from the back side of the heater plate. Molybdenum leads were bonded to the heater layer and the RF electrode by brazing with an active braze metal, 63% silver, 34.25% copper, 1% tin and 1.75% titanium, at approximately 850° C. in an inert atmosphere. The heater layer or heater element was then energized and the heater plate was successfully heated to approximately 400° C. In addition, the heater plate was thermally cycled between room temperature and 400° C. several times, by switching the power to the heater layer on and off. At the end of the thermal cycling, no problems were detected, thus indicating reliable operation of the heater.

Further modifications and equivalents of the invention herein disclosed will occur to persons skilled in the art using no more than routine experimentation and all such modifications and equivalents are believed to be within the spirit and scope of the invention as defined by the following claims.

What is claimed is:

1. A heater comprising:
a thermally conductive ceramic layer;
a thermally insulative ceramic layer contacting the thermally conductive ceramic layer; and
a ceramic heater element embedded within the thermally conductive ceramic layer.

2. The heater as in claim 1, wherein the thermally conductive ceramic layer comprises aluminum nitride.

3. The heater as in claim 2, wherein the thermally insulative ceramic layer comprises aluminum nitride and a dopant.

4. The heater as in claim 3, wherein the ceramic heater element comprises aluminum nitride and at least one of molybdenum, molybdenum disilicide and silicon carbide.

5. The heater as in claim 4, wherein the thermally conductive ceramic layer comprises at least about 50% by weight aluminum nitride.

6. The heater as in claim 5, wherein the ceramic heater element comprises about 25% to about 57% by weight molybdenum and about 42% to about 74% by weight aluminum nitride.

7. The heater as in claim 5, wherein the ceramic heater element comprises about 5% to about 40% by weight silicon carbide, about 5% to about 50% by weight molybdenum disilicide and about 15% to about 70% by weight aluminum nitride.

8. The heater as in claim 7, wherein the dopant is at least one of oxygen and a rare earth element.

9. The heater as in claim 8, wherein the thermally insulative ceramic layer comprises at least about 0.1% by weight oxygen and at least about 50% by weight aluminum nitride.

10. The heater as in claim 9, further comprising a sensor for measuring a temperature of at least one of the thermally conductive ceramic layer and a semiconductor wafer in contact with the thermally conductive ceramic layer.

11. The heater as in claim 10, wherein the thermally insulative ceramic layer further comprises a second dopant.

12. The heater as in claim 11, wherein the second dopant is at least one of oxygen and a rare earth element.

13. The heater as in claim 12, further comprising a RF electrode embedded within the thermally conductive ceramic layer.

14. A method for heating a semiconductor wafer comprising:
adjusting an electrical resistivity of a ceramic heater element;
providing a heater comprising a thermally conductive ceramic layer, a thermally insulative ceramic layer and a ceramic heater element embedded within the thermally conductive layer;
generating a quantity of thermal energy from the ceramic heater element; and
transferring at least a portion of the generated thermal energy to the semiconductor wafer.

15. The method as in claim 14, wherein the thermally conductive ceramic layer comprises aluminum nitride.

16. The method as in claim 15, wherein the thermally insulative ceramic layer comprises aluminum nitride and a dopant.

17. The method as in claim 16, wherein the ceramic heater element comprises aluminum nitride and at least one of molybdenum, molybdenum disilicide and silicon carbide.

18. The method as in claim 17, wherein the ceramic heater element comprises about 25% to about 57% by weight molybdenum and about 42% to about 74% by weight aluminum nitride.

19. The method as in claim 17, wherein the thermally conductive ceramic layer is at least about 50% by weight aluminum nitride.

20. The method as in claim 19, wherein the ceramic heater element comprises about 15% to about 70% aluminum nitride and 5% to about 50% molybdenum disilicide

21. The method as in claim 20, wherein the step of generating the quantity of thermal energy comprises applying an electrical current through the ceramic heater element.

22. The method as in claim 21, wherein the ceramic heater element further comprises silicon carbide.

23. The method as in claim 22, wherein the silicon carbide is about 5% to about 40% by weight.

24. The method as in claim 14, wherein the step of adjusting the electrical resistivity of the ceramic heater element comprises adjusting the composition of the ceramic heater element.

25. The method as in claim 24, further comprising the step of measuring the temperature of the semiconductor wafer.

26. The method as in claim 25, wherein the step of generating the quantity of thermal energy further comprises controlling the electrical current in a control loop.

27. A semiconductor wafer temperature controller comprising:
a thermally conductive ceramic layer for supporting the semiconductor wafer;
a thermally insulative ceramic layer for supporting the thermally conductive ceramic layer;
a ceramic heater element in thermal communication with the thermally conductive ceramic layer and positioned between the thermally conductive and thermally insulative ceramic layers;
an electrical power supply connected to the ceramic heater element;
a sensor for measuring the temperature of at least one of the semiconductor wafer and the thermally conductive ceramic layer; and
a control loop connected to the sensor and the electrical power supply.

28. A semiconductor wafer heater comprising:
a thermally conductive ceramic layer for supporting a semiconductor wafer;
a thermally insulative ceramic layer in contact with the thermally conductive ceramic layer; and
a ceramic heater element embedded between the thermally conductive ceramic layer and the thermally insulative ceramic layer,
wherein the thermally conductive ceramic layer, the thermally insulative ceramic layer and the ceramic heater element have substantially the same coefficient of thermal expansion.

29. A method of producing a ceramic heater comprising:
adding a first ceramic to a mold;
mixing an electrically conductive material and an electrically insulative material into a mixture;
transferring the mixture into the mold;
blending a second ceramic with a dopant;
transferring the second ceramic with the dopant into the mold; and
hot pressing the mold at a temperature of at least 1800° C. to produce the ceramic heater.

30. A heater comprising:
a thermally conductive ceramic layer;
a thermally insulative ceramic layer contacting the thermally conductive ceramic layer; and
a ceramic heater element embedded between the thermally conductive layer and the thermally insulative layer.

31. A method for heating a semiconductor wafer comprising:
adjusting an electrical resistivity of a ceramic heater element;
providing a heater comprising a thermally conductive ceramic layer, a thermally insulative ceramic layer and a ceramic heater element embedded between the thermally conductive and the thermally insulative layers;
generating a quantity of thermal energy from the ceramic heater element; and
transferring at least a portion of the generated thermal energy to the semiconductor wafer.
